(19) United States
(12) Patent Application Publication
(10) Pub. No.: US 2013/0068813 A1
(43) Pub. Date: Mar. 21, 2013

(54) FLOATING TRUNK STORAGE COMPARTMENT

(71) Applicants: Roy Choates, Johns Creek, GA (US); Charles Hunter, Johns Creek, GA (US)

(72) Inventors: Roy Choates, Johns Creek, GA (US); Charles Hunter, Johns Creek, GA (US)

(21) Appl. No.: 13/623,078

(22) Filed: Sep. 19, 2012

Related U.S. Application Data
(60) Provisional application No. 61/536,323, filed on Sep. 19, 2011.

(51) Int. Cl. B62J 9/00; B60R 9/00

(52) U.S. Cl. 224/413; 224/519

(57) ABSTRACT

A floating trunk storage compartment for three wheeled motorcycles provides waterproof storage without the need and associates expenses of a trailer. The floating trunk storage compartment includes a receiver hitch bar to fit into a receiver hitch of the motorcycle. The floating trunk storage compartment rides behind the motorcycle, off the ground, to provide significant storage space. Without the wheels, bearings, axles and other components associated with a conventional trailer, the floating trunk storage compartment can easily be removed and stored or put into service on the back of the motorcycle.

### CROSS-REFERENCE TO RELATED APPLICATION

This application claims the benefit of priority of U.S. provisional application No. 61/536,323, filed Sep. 19, 2011, the contents of which are herein incorporated by reference.

### BACKGROUND OF THE INVENTION

The present invention relates to motorcycle storage compartments and, more particularly, to a floating trunk storage compartment for three-wheeled motorcycles.

There is a limit to the amount of storage space available on a motorcycle, including three wheeled motorcycles. This space is limited to saddle bags and other hard cases that can be attached to the motorcycle.

Conventional trailers are available for motorcycles. Such trailers, however, have substantial additional costs associates with their use. For example, in most states, such trailers need to be separately registered and have their own tag. In addition, there is additional maintenance associated with these trailers, such as wheel, tire and bearing maintenance. Moreover, these conventional trailers can be heavy and can take up valuable storage space.

As can be seen, there is a need for a storage compartment for a motorcycle that can provide significant storage space without the issues associated with a tow behind trailer.

### SUMMARY OF THE INVENTION

In one aspect of the present invention, a floating trunk storage compartment comprises a main body forming at least one interior compartment; at least one door providing access to the interior compartment; and a receiver hitch bar operable to secure to a receiver hitch of a vehicle.

In another aspect of the present invention, a motorcycle storage system comprises a main body forming at least one interior compartment; first and second doors disposed on opposite sides of the main body providing access to the interior compartment; and a receiver hitch bar operable to secure to a receiver hitch of a vehicle, wherein the motorcycle storage system is configured to float behind a motorcycle without riding on wheels.

In a further aspect of the present invention, a floating trunk providing waterproof storage for a motorcycle comprises a main body forming at least one interior compartment; first and second doors disposed on opposite sides of the main body providing access to the interior compartment; a receiver hitch bar operable to secure to a receiver hitch of a vehicle; a lock on the at least one door; and a rack disposed over at least a portion of a top surface of the main body, wherein the motorcycle storage system is configured to float behind a motorcycle without riding on wheels.

These and other features, aspects and advantages of the present invention will become better understood with reference to the following drawings, description and claims.

### BRIEF DESCRIPTION OF THE DRAWINGS

FIG. 1 is a perspective view of a floating trunk storage compartment, attached to a three wheeled motorcycle according to an exemplary embodiment of the present invention;

FIG. 2 is a perspective view of the floating trunk storage compartment of FIG. 1, detached from the motorcycle;

FIG. 3 is a perspective view of the floating trunk storage compartment of FIG. 1;

FIG. 4 is a perspective view of the floating trunk storage compartment of FIG. 1 with its doors opened;

FIG. 5 is a front view of the floating trunk storage compartment of FIG. 1 showing movement of the doors and an exemplary, optional front light configuration;

FIG. 6 is a rear view of the floating trunk storage compartment of FIG. 1 showing movement of the doors and an exemplary, optional rear light configuration; and

FIG. 7 is a side view of the floating trunk storage compartment of FIG. 1 showing an exemplary, optional side light configuration.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a floating trunk storage compartment for three wheeled motorcycles that provides waterproof storage without the need and associates expenses of a trailer. The floating trunk storage compartment includes a receiver hitch bar to fit into a receiver hitch of the motorcycle. The floating trunk storage compartment rides behind the motorcycle, off the ground, to provide significant storage space. Without the wheels, bearings, axles and other components associated with a conventional trailer, the floating trunk storage compartment of the present invention can easily be removed and stored or put into service on the back of the motorcycle. The floating trunk storage compartment of the present invention is specially adapted for use with three wheeled motorcycles, both those with two front wheels and those with two rear wheels.

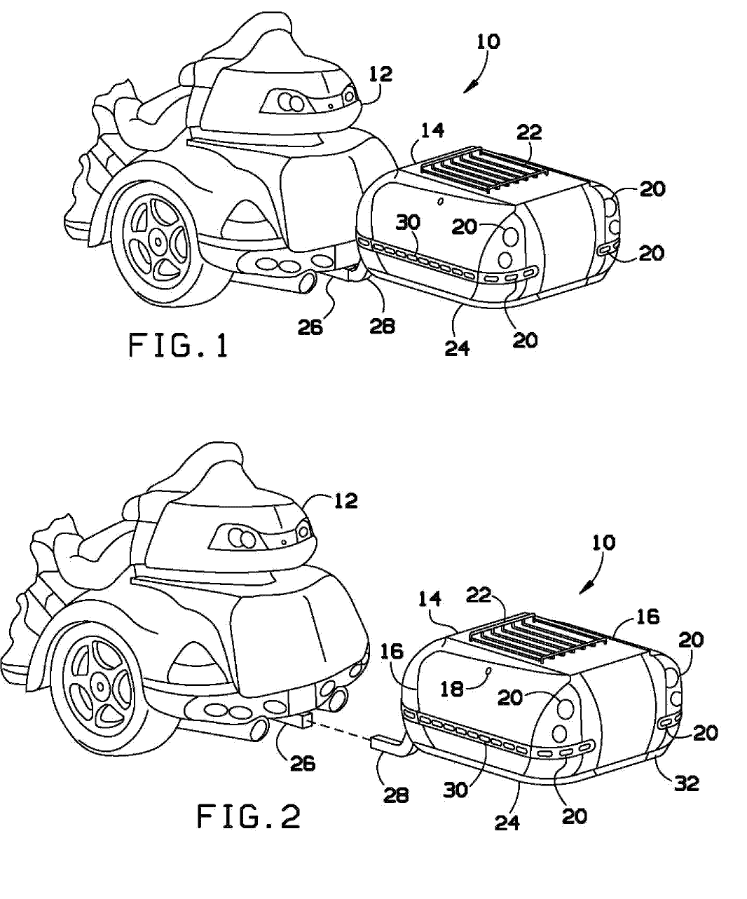

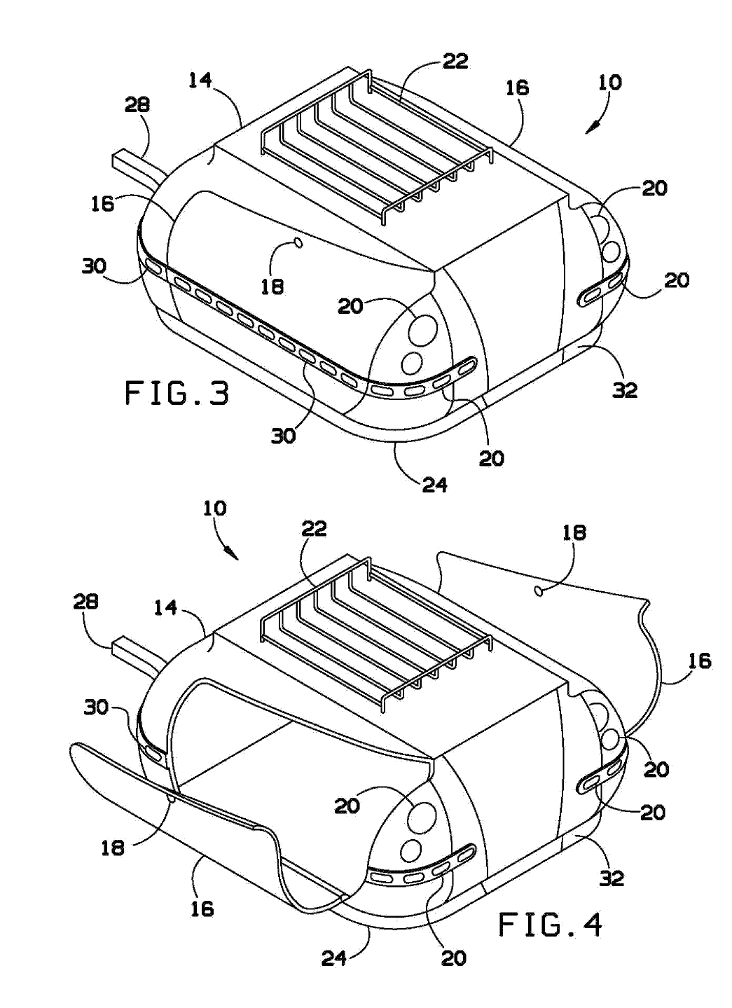

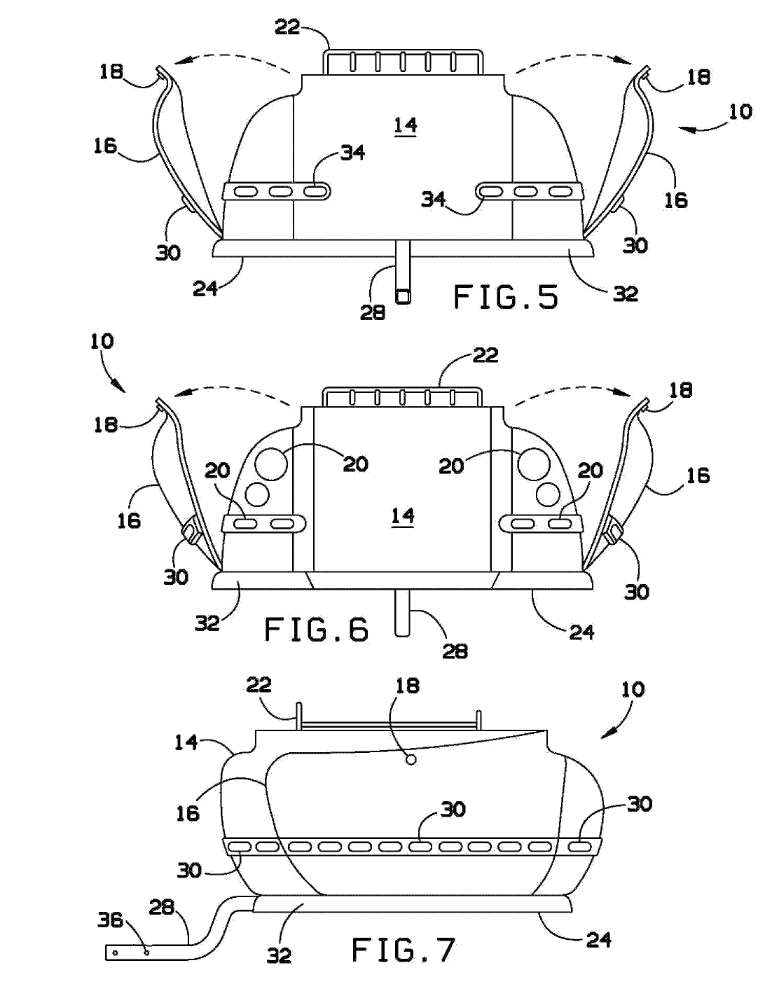

Referring now to FIGS. 1 through 7, a floating trunk storage compartment 10 can be used to provide additional storage space on a three wheeled motorcycle 12. The floating trunk storage compartment 10 can include a receiver hitch bar 28 that fits into a receiver hitch 26 of the three wheeled motorcycle 12, as shown in FIGS. 1 and 2. The receiver hitch bar 28 can include adjustment holes 36 for providing an adjustment of the separation between the floating trunk storage compartment 10 and the motorcycle 12. One of the adjustment holes 36 can be disposed near the end of the receiver hitch bar 28 to provide a distance between the compartment 10 and the motorcycle 12 that can be useful for a person to get therebetween. Another one of the adjustment holes 36 can be disposed rearward in the receiver hitch bar 28, to provide a close fit between the compartment 10 and the motorcycle 12, ideal for riding.

A trunk base trim 32 can be provided about the periphery of the bottom of the floating trunk storage compartment 10. The trunk base trim 32 can help protect the floating trunk storage compartment 10 from sustaining damage, especially when installing or removing the device from the motorcycle. The trunk base trim 32 can be made from various materials, such as plastic, rubber, or the like.

The floating trunk storage compartment 10 can include a main body 14 forming an outer case thereof. Doors 16 may be disposed on sides of the main body 14 to provide access to an interior of the floating trunk storage compartment 10. Typically, a door 16 can be disposed on each side of the floating trunk storage compartment 10. However, other configuration of doors are contemplated within the scope of the present invention. For example, a door could be formed from a hinged top portion of the main body 14. The doors 16 can include a lock 18 to prevent unauthorized access to items stored inside the floating trunk storage compartment 10. The doors 16 can include appropriate seals (not shown) to provide a waterproof closure.

The floating trunk storage compartment 10 of the present invention can be made, for example, from hard saddle bags, where each door 16 on each side of the main body 14 creates a separate storage chamber. In some embodiments, the inside of the floating trunk storage compartment 10 can be a single space, can include dividers for organization, can include loops for tie downs to prevent content shifting and other similar features. Such configurations, and others, depending on the intended application and needs of the user, are included within the scope of the present invention.

The floating trunk storage compartment 10 of the present invention can include a rack 22 disposed over at least a portion of a top part of the main body 14. The rack 22 can be used for strapping down items for additional, non-weather proof storage. The rack 22 can be sized and shaped similar to conventional racks to allow the use of various rack storage accessories, for example.

The floating trunk storage compartment 10 of the present invention can include various lighting options. Because the floating trunk storage compartment 10 can be designed to ride below taillights of the motorcycle, lights, such as brake lights, turning signals, tail lights, running lights, and the like, can be considered optional. Exemplary options for lighting accessories for the floating trunk storage compartment 10 are described below. The lights can be made from various light styles. For example, light emitting diodes (LEDs) can be used to provide bright lights at relatively low power consumption. Of course, when lights are included, the floating trunk storage compartment 10 can include a power lead (not shown) typically running along the same path as the receiver hitch bar 28 that connects to a power socket on the motorcycle.

Rear lights 20 can be included on the floating trunk storage compartment 10. Such rear lights 20 can include tail lights, brake lights, and turn signals. The rear lights 20 can be controlled through the power lead from the motorcycle.

Side lights 30 can be included along each side of the floating trunk storage compartment 10. The side lights 30 can be designed to be on anytime the motorcycle is powered on, or, in some embodiments, a separate switch can be provided to turn the side lights 30 on and off.

Front lights 34 can be included on the front of the floating trunk storage compartment 10. Typically, the front lights 34 can be disposed on each side of the front of the main body 14. The front lights 34 can be designed to be on anytime the motorcycle is powered on, or, in some embodiments, a separate switch can be provided to turn the front lights 34 on and off.

The floating trunk storage compartment 10 can be made from various materials in methods known in the art. For example, a metal support structure, made from iron, aluminum, steel, or the like, can be used to provide the receiver hitch bar 28 and the appropriate support for the main body 14. Other materials, such as plastic, fiberglass and the like can be used for the main body. Depending on the materials used, the floating trunk storage compartment 10 can be designed to keep a certain maximum weight. This weight limit can be, for example, about 50 pounds.

While the above description and associated drawings describe a floating trunk storage compartment for a three wheeled motorcycle, the device of the present invention could be used on other vehicles. For example, the floating trunk storage compartment could be useful to be attached to cars or trucks when additional dry storage is needed.

It should be understood, of course, that the foregoing relates to exemplary embodiments of the invention and that modifications may be made without departing from the spirit and scope of the invention as set forth in the following claims.

What is claimed is:

1. A floating trunk storage compartment comprising:
a main body forming at least one interior compartment;
at least one door providing access to the interior compartment; and
a receiver hitch bar operable to secure to a receiver hitch of a vehicle.

2. The floating trunk storage compartment of claim 1, further comprising a first door on one side of the main body and a second door on an opposite side of the main body.

3. The floating trunk storage compartment of claim 1, further comprising a lock on the at least one door.

4. The floating trunk storage compartment of claim 1, further comprising rear lights operable as tail lights, brake lights and turning signals.

5. The floating trunk storage compartment of claim 1, further comprising side lights.

6. The floating trunk storage compartment of claim 1, further comprising front lights.

7. The floating trunk storage compartment of claim 1, further comprising a rack disposed over at least a portion of a top surface of the main body.

8. The floating trunk storage compartment of claim 1, further comprising at least two adjustment holes in the receiver hitch bar to adjustably dispose the receiver hitch bar in the receiver hitch.

9. A motorcycle storage system comprising:
a main body forming at least one interior compartment;
first and second doors disposed on opposite sides of the main body providing access to the interior compartment; and
a receiver hitch bar operable to secure to a receiver hitch of a vehicle, wherein
the motorcycle storage system is configured to float behind a motorcycle without riding on wheels.

10. The motorcycle storage system of claim 9, further comprising a lock on the at least one door.

11. The motorcycle storage system of claim 9, further comprising rear lights operable as tail lights, brake lights and turning signals.

12. The motorcycle storage system of claim 9, further comprising:
side lights disposed on sides of the main body; and
front lights disposed on a front surface of the main body.

13. The motorcycle storage system of claim 9, further comprising a rack disposed over at least a portion of a top surface of the main body.

14. A floating trunk providing waterproof storage for a motorcycle, comprising:
a main body forming at least one interior compartment;
first and second doors disposed on opposite sides of the main body providing access to the interior compartment;
a receiver hitch bar operable to secure to a receiver hitch of a vehicle;
a lock on the at least one door; and
a rack disposed over at least a portion of a top surface of the main body, wherein
the motorcycle storage system is configured to float behind a motorcycle without riding on wheels.

15. The floating trunk of claim 14, further comprising rear lights operable as tail lights, brake lights and turning signals.

16. The floating trunk of claim 14, further comprising:
side lights disposed on sides of the main body; and
front lights disposed on a front surface of the main body.
